(19) United States
(12) Patent Application Publication
(10) Pub. No.: US 2018/0100669 A1
(43) Pub. Date: Apr. 12, 2018

(54) EXTERIOR RIGGING POINTS FOR HVAC UNITS

(71) Applicant: Johnson Controls Technology Company, Milwaukee, WI (US)

(72) Inventors: Curtis W. Caskey, Dallastown, PA (US); David H. Bechtold, Johnstown, PA (US); Troy E. Smith, Dallastown, PA (US); Brian J. Zinn, Lewisberry, PA (US)

(21) Appl. No.: 15/714,853

(22) Filed: Sep. 25, 2017

Related U.S. Application Data
(60) Provisional application No. 62/406,350, filed on Oct. 10, 2016.

(51) Int. Cl. F24F 13/20; F24F 13/32; B23P 19/04

(52) U.S. Cl. CPC F24F 13/20; F24F 13/32; F24F 2221/32; F24F 2221/16; F24F 2221/12; B23P 19/04

(57) ABSTRACT

The present disclosure relates to a heating, ventilating, and air conditioning (HVAC) unit that includes a plurality of lifting lugs coupled to the HVAC unit. The HVAC unit also includes a cable that is threaded through each of the plurality of lifting lugs and coupled to an exterior of the HVAC unit.

### CROSS REFERENCE TO RELATED APPLICATIONS

This application claims priority from and the benefit of U.S. Provisional Application Ser. No. 62/406,350, entitled “EXTERIOR RIGGING POINTS FOR SAFETY HARNESS,” filed Oct. 10, 2016, which is hereby incorporated by reference.

### BACKGROUND

The present disclosure relates generally to heating, ventilating, and air conditioning systems. A wide range of applications exist for heating, ventilating, and air conditioning (HVAC) systems. For example, residential, light commercial, commercial, and industrial systems are used to control temperatures and air quality in residences and buildings. Such systems often are dedicated to either heating or cooling, although systems are common that perform both of these functions. Very generally, these systems operate by implementing a thermal cycle in which fluids are heated and cooled to provide the desired temperature in a controlled space, typically the inside of a residence or building. Similar systems are used for vehicle heating and cooling, and as well as for general refrigeration. In many HVAC systems, an HVAC unit may be positioned on a rooftop. In such circumstances, technicians or other personnel may use safety harnesses while working on or around the HVAC unit.

### SUMMARY

The present disclosure relates to a heating, ventilating, and air conditioning (HVAC) unit that includes a plurality of lifting lugs coupled to the HVAC unit. The HVAC unit also includes a cable that is threaded through each of the plurality of lifting lugs and coupled to an exterior of the HVAC unit.

The present disclosure also relates to a heating, ventilating, and air conditioning (HVAC) system that is configured to supply conditioned air to a building. The HVAC system includes an HVAC unit, and the HVAC unit includes a cabinet, a plurality of lifting lugs coupled to the cabinet, and a cable that extends through each lifting lug of the plurality of lifting lugs. Additionally, the cable is configured to be attached to an attachment device.

The present disclosure further relates to a method that includes securing a plurality of attachment points to a base rail of a heating, ventilating, and air conditioning (HVAC) unit. The method also includes threading a cable through each attachment point of the plurality of attachment points and securing the cable to the HVAC unit.

### DRAWINGS

FIG. 1 is a perspective view a heating, ventilating, and air conditioning (HVAC) system for building environmental management, in accordance with embodiments described herein;

FIG. 2 is a perspective view of the HVAC unit of FIG. 1, in accordance with embodiments described herein;

FIG. 3 is a perspective view of a residential heating and cooling system, in accordance with embodiments described herein;

FIG. 4 is a schematic diagram of a vapor compression system that may be used in the HVAC system of FIG. 1 and the residential heating and cooling system FIG. 3, in accordance with embodiments described herein;

FIG. 5 is a perspective view of an HVAC unit that includes an exterior cable to which an attachment device may be attached, in accordance with embodiments described herein; and

FIG. 6 is a flow chart of a method for adding a cable to an HVAC unit, in accordance with embodiments described herein.

### DETAILED DESCRIPTION

The present disclosure is directed to heating, ventilating, and air conditioning (HVAC) systems and units, such as rooftop HVAC units, that include an exterior cable to which a work harness or other attachment device may be coupled. In general, the cable is coupled to an exterior of an HVAC unit via lifting lugs of the HVAC unit, which are typically installed and used for lifting and positioning the HVAC unit on a rooftop. In certain embodiments, the cable may be a permanent fixture or feature of the HVAC unit.

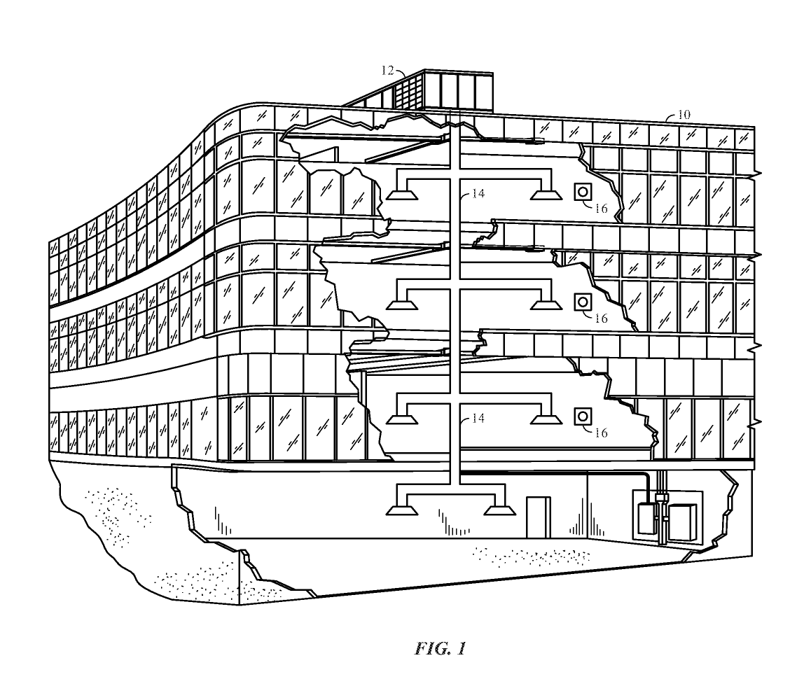

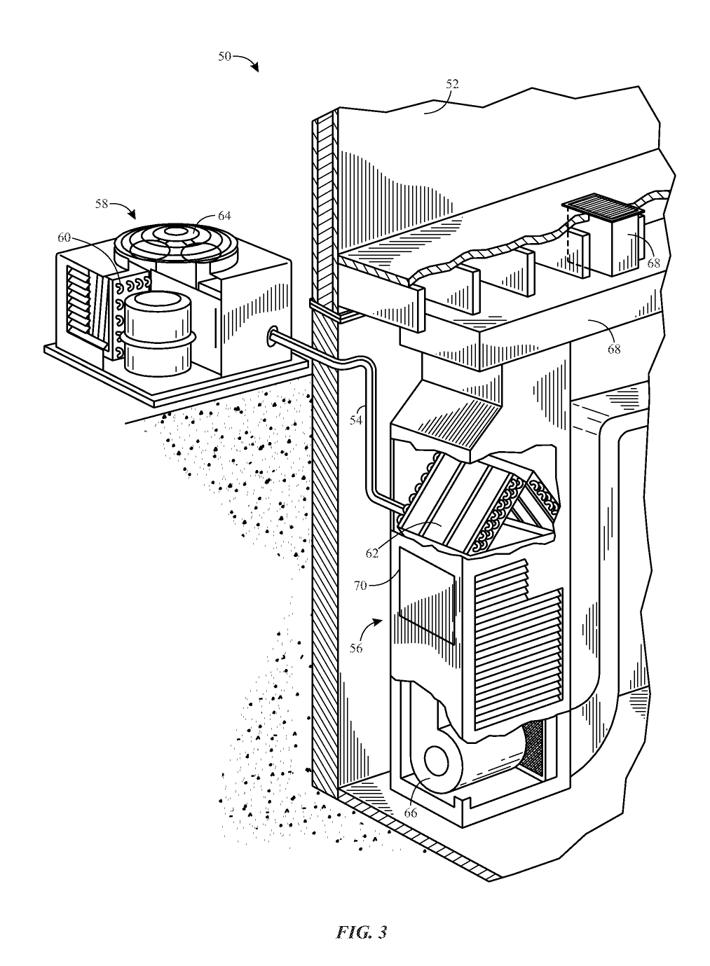

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

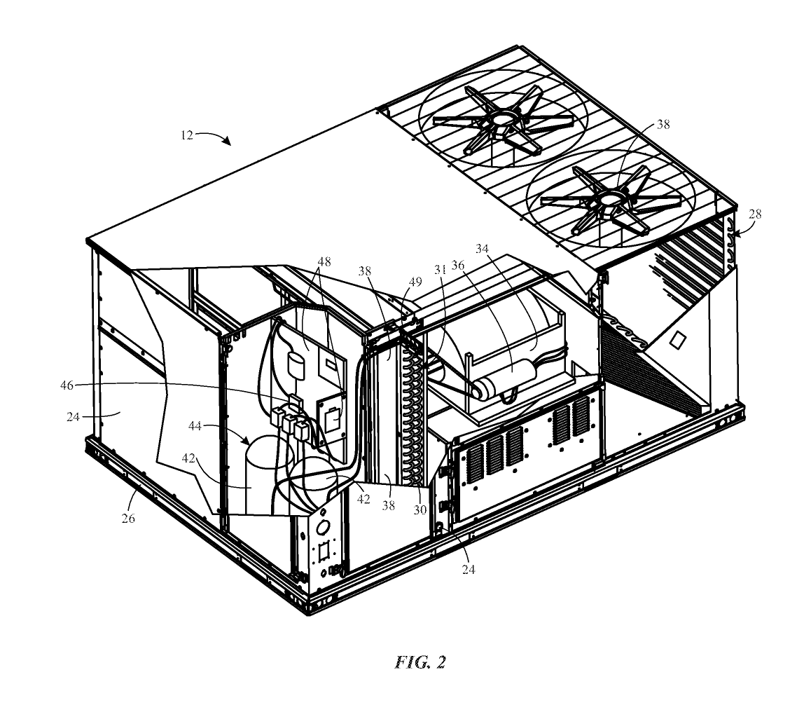

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

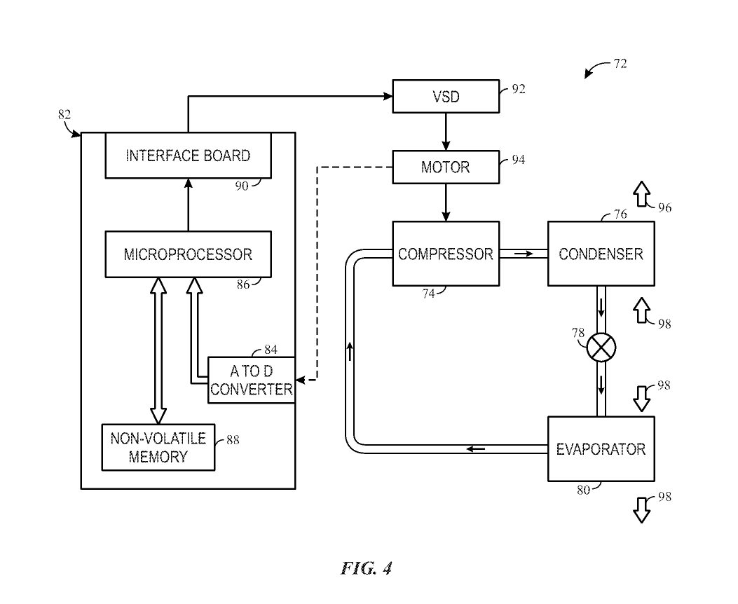

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

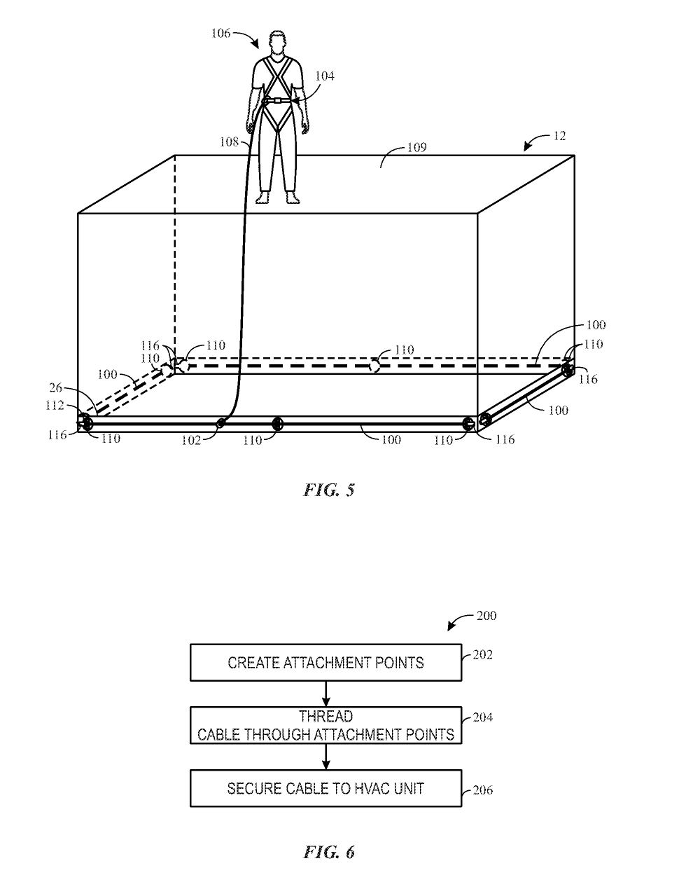

As discussed below, an HVAC unit such as HVAC unit 12 includes a cable to which a carabiner, harness, or other attachment device may be coupled. Technicians may utilize the cable to secure themselves to the HVAC unit 12 while they inspect and/or repair the HVAC unit 12. For example, FIG. 5 is a perspective view of HVAC unit 12 that includes a cable 100 that may to which an attachment device 102 may be fastened. While HVAC unit 12 is a rooftop unit, it should be noted that the cable 100 may also be included on other types of HVAC units, such as HVAC units that are not rooftop units. While the HVAC unit 12 may be positioned in various locations on the rooftop of a building, such as building 10, it should be noted that the HVAC unit 12 may be located in a specific location relative to a ledge of the rooftop of the building 12. For example, the HVAC unit 12 may be fully or partially located at or within ten feet of a ledge of the building 10.

The attachment device 102 may be a carabiner, metal loop, clip, or the like. In operation, the attachment device 102 is coupled to the cable 100 and a harness 104 worn by a technician 106 via a line 108, which may be a cable, rope, or other line. In other words, the technician 106 may secure himself or herself to the HVAC unit 12 by utilizing the cable 100. The technician may move about the area surrounding the HVAC unit 12, as well a top surface 109 of the HVAC unit 12 while coupled to the cable 100. As the technician moves about, the attachment device 102 may move freely along the cable 100.

As illustrated, the cable 100 may be secured to the HVAC unit 12 via lifting lugs 110. The lifting lugs 110, which may be eye bolts or another implement that includes a hole through which the cable 100 may be inserted, may be coupled to holes 112 in the rails 26 of the HVAC unit. More specifically, the lifting lugs 110 may be coupled to the HVAC unit 12 so that the HVAC unit 12 may be hoisted onto a rooftop, such as the rooftop of the building 10. While the illustrated embodiment includes three liftings lugs 110, in other embodiments, the cable 100 may be secured via two, four, or more lifting lugs 110. In certain embodiments, the cable 100 may be routed through the lifting lugs 110 and then secured to the rails 26 or other component of the HVAC unit 12. In other embodiments, the cable 100 may be routed through the lifting lugs 110 and also secured or fastened to the lifting lugs 110.

The cable 100 may be made from various metals and metal alloys, such as stainless steel and carbon steel. Additionally, the cable 100 may be rated to support various loads. For example, the cable 100 may be rated to support a weight that is greater than weights typically associated with humans. For example, the cable 100 may be rated to support a weight of 300 pounds, 400 pounds, 500 pounds, 600 pounds, or a weight greater than 600 pounds.

As shown in FIG. 5, the cable 100 may be held in place by the lifting lugs 110 and extend across a length of the rail 26 of the HVAC unit 12. In some embodiments, the cable 100 may be secured in place via a mechanical fastener or device. For example, links 116 may be attached to one or more ends of the cable 100, and the links 116 may hold the cable 100 in place. The links 116 may include cable clamps and cable seals. As mentioned above, the links 116 may be secured to the lifting lugs 110, the rail 26, or another component of the HVAC unit 12. In other embodiments, the cable 100 may be secured in place without using links 116. For example, the cable 100 may be tied to the lifting lugs 110 or knots may be formed at ends of the cable 100 to prevent the cable 100 from becoming unthreaded from the lifting lugs 110. Additionally, the cable 100 may become a permanent fixture of the HVAC unit 12 after the cable 100 has been installed on the HVAC unit 12. In this manner, the cable 100 may be used repeatedly by multiple technicians or operators without installation, uninstallation, reinstallation, and so forth.

It should also be noted that while the illustrated embodiment of the HVAC unit 12 includes four cables 100, in other embodiments, the HVAC unit 12 may include less than four cables 100. For instance, some sides of the HVAC unit may include a cable 100, while one or more other sides of the HVAC unit 12 may not include a cable 100. Furthermore, in other embodiments, one cable 100 may extend along more than one side of the HVAC unit 12. For example, a single cable 100 may extend along the entire perimeter of the HVAC unit 12.

Additionally, while the illustrated embodiment shows that the cable 100 is threaded through the lifting lugs along the rail 26 of the HVAC unit 12 and, in other embodiments, the cable 100 may be positioned elsewhere along the HVAC 12. For instance, attachment points, such as eye bolts may be coupled to another portion of the HVAC unit 12, and the cable 100 may be threaded through the attachment points and secured to the HVAC unit 12 as described above.

With the discussion of FIG. 5 in mind, FIG. 6 is a flow chart of a method 200 for adding the cable 100 to the HVAC unit 12. The method 200 may be performed prior to the HVAC unit 12 being placed on a rooftop or after the HVAC unit 12 has been placed on a rooftop. Moreover, it should be noted that the method 200 may be performed on HVAC units 12 that are not located on or designed for rooftops.

At block 202, attachment points to the HVAC unit 12 may be created. For example, lifting lugs 110 may be coupled to the HVAC unit 12. As mentioned above, the lifting lugs 110 are typically installed for use when lifting the HVAC unit 12 onto building 10, onto another structure, or for otherwise moving the HVAC unit 12. At block 204, the cable 100 may be threaded through the lifting lugs 110. As discussed above, the lifting lugs 110 may include holes through which the cable 100 may be fed. Additionally, threading the cable 100 through the lifting lugs 110 may include threading the cable 100 through any whole number of lifting lugs 110 that is greater than one.

At block 206, the cable 100 may be secured to the HVAC unit 12. For example, one or more ends of the cable 100 may be coupled to links 116. The links 116 may be configured to directly abut the lifting lugs 110 that are positioned on ends of the HVAC unit 12. However, it should be noted that in other embodiments, the cable 100 may be secured to the HVAC unit 12 in a different manner. For instance, the cable 100 may be tied to the lifting lugs 110 or knots may be formed at ends of the cable 100 to prevent the cable 100 from becoming unthreaded from the lifting lugs 110.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described (i.e., those unrelated to the presently contemplated best mode of carrying out the present disclosure, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilating, and air conditioning (HVAC) unit, comprising:
a plurality of lifting lugs coupled to the HVAC unit; and
a cable, wherein the cable is threaded through each of the plurality of lifting lugs, and the cable is coupled to an exterior of the HVAC unit.

2. The HVAC unit of claim 1, wherein each of the plurality of lifting lugs comprises an opening, wherein the cable is disposed within each of the respective openings of the plurality of lifting lugs.

3. The HVAC unit of claim 2, wherein the plurality of lifting lugs comprises two, three, or four lifting lugs.

4. The HVAC unit of claim 2, comprising a plurality of links, wherein the cable is held in place via the plurality of links.

5. The HVAC unit of claim 4, wherein each link of the plurality of links is configured to be coupled to an end of the cable.

6. The HVAC unit of claim 2, wherein each lifting lug of the plurality of lifting lugs is coupled to a base rail of the HVAC unit.

7. The HVAC unit of claim 1, comprising an attachment device coupled to the cable.

8. The HVAC unit of claim 7, wherein the attachment device comprises a carabiner or hook.

9. The HVAC unit of claim 1, wherein the HVAC unit is a rooftop unit.

10. A heating, ventilating, and air conditioning (HVAC) system configured to supply conditioned air to a building, wherein the HVAC system comprises an HVAC unit, and the HVAC unit comprises:
a cabinet;
a plurality of lifting lugs coupled to the cabinet; and
a cable extending through each lifting lug of the plurality of lifting lugs, wherein the cable is configured to be attached to an attachment device.

11. The HVAC system of claim 10, wherein the HVAC unit is a rooftop unit.

12. The HVAC system of claim 10, wherein the cable is rated to support a weight equal to or greater than 300 pounds.

13. The HVAC system of claim 10, wherein the cable comprises a metal or metal alloy.

14. The HVAC system of claim 13, wherein the cable comprises stainless steel.

15. The HVAC system of claim 10, wherein the cable is a permanent fixture of the HVAC unit.

16. The HVAC system of claim 10, wherein the cable enables the attachment device to move along the cable.

17. The HVAC system of claim 10, wherein the plurality of lifting lugs is a first plurality of lifting lugs, and the cable is a first cable, and wherein the HVAC system comprises a second plurality of lifting lugs and a second cable extending through each lifting lug of the second plurality of lifting lugs.

18. The HVAC system of claim 17, wherein the first plurality of lifting lugs and the second plurality of lifting lugs are coupled to a base rail of the HVAC unit.

19. A method comprising:
securing a plurality of attachment points to a base rail of a heating, ventilating, and air conditioning (HVAC) unit;
threading a cable through each attachment point of the plurality of attachment points; and
securing the cable to the HVAC unit.

20. The method of claim 19, wherein the plurality of attachment points comprises a plurality of lifting lugs.

21. The method of claim 20, wherein securing the plurality of attachment points to the base rail of the HVAC unit comprises coupling the plurality of lifting lugs to a plurality of holes in the base rail of the HVAC unit.

22. The method of claim 19, wherein securing the cable to the HVAC unit comprises attaching links to ends of the cable.

23. The method of claim 19, wherein securing the cable to the HVAC unit comprises securing the cable to the HVAC unit via fasteners positioned on sides of the HVAC unit.
